(19) United States
(12) Patent Application Publication
(10) Pub. No.: US 2025/0225215 A1
(43) Pub. Date: Jul. 10, 2025

(54) SYSTEMS AND METHODS FOR ADJUSTING ACCESS PARAMETERS OF AUTHENTICATION TOKENS

(71) Applicant: Capital One Services, LLC, McLean, VA (US)

(72) Inventors: Jeffrey Carlyle WIEKER, Falls Church, VA (US); Pavel FORT, Westbury, NY (US); Jackson MACOMBER, Henrico, VA (US)

(73) Assignee: Capital One Services, LLC, McLean, VA (US)

(21) Appl. No.: 18/408,217

(22) Filed: Jan. 9, 2024

(51) Int. Cl. G06F 21/31

(52) U.S. Cl. CPC G06F 21/31

(57) ABSTRACT

Methods and systems for adjusting access parameters for authentication tokens. In some aspects, the system receives an authorization request associated with a first authorization token for a user account and determines that access parameters for the first authorization token do not include resources associated with the authorization request. The system processes, using a real time model, the authorization request and a first set of features to generate a first degree of confidence indicating a likelihood of adjusting access parameters. Using the first degree of confidence, the system determines whether to grant the authorization request and transmit a response. The system then processes a second set of features using a comprehensive model to determine whether to adjust the access parameters for the first authorization token. The system may adjust the access parameters for the first authorization token and generate a notification to a user associated with the user account.

### SUMMARY

Authentication tokens offer users convenience when accessing devices or services requiring authorization, such as a computer system or a cloud computing resource. However, conventional authentication tokens can be difficult to modify once issued. In some instances, access parameters for such tokens may become outdated when the needs of users or the systems they access change, with no method for updating the parameters defining the authentication tokens. Additionally, conventional systems can face challenges in determining the scope of changes to authentication tokens necessitated by the needs of users or usage of the authentication tokens.

Existing systems have not contemplated processing metadata associated with an authorization request, such as past authorization requests or the usage history of the authentication token, to determine approval for the authorization request or make adjustments to the access parameters as necessary. Methods and systems are described herein for novel uses and/or improvements to artificial intelligence applications and in particular to using a real-time machine learning model and a comprehensive machine learning model to determine approval for authorization requests or for adjusting access parameters of authentication tokens. For example, the system may receive an authorization request associated with a first authorization token for a user account, where access parameters for the first authorization token do not include resources associated with the authorization request. The system may use a real-time model to process the authorization request and generate a first degree of confidence for whether to approve the authorization request. The real-time model may be responsive and able to provide approval decisions as authorization requests are received, sometimes in instances where the approval decision may fall outside of the access parameters of the authentication token. The system may subsequently use a comprehensive machine learning model to process a second set of features including approved and declined authorization requests associated with the user account and determine whether to adjust access parameters of the authentication token, or if needed, annotate a previous approval decision from the real-time model as incorrect, e.g., for feedback to the real-time model. The comprehensive machine learning model may take more input features for consideration, and the system accordingly may use its output to inform appropriate access coverage for the authentication token, for which the authentication token can be adjusted appropriately. By doing so, the system identifies genuine authorization requests and responds to user's needs for authentication tokens, while maintaining flexibility and accuracy in adjusting access parameters for authentication tokens at minimal inconvenience to the user.

In some aspects, a method for adjusting access parameters for an authentication token is disclosed herein, the method comprising: receiving an authorization request associated with a first authorization token for a user account; determining that access parameters for the first authorization token do not include resources associated with the authorization request; processing, using a real time model, the authorization request and a first set of features to generate a first degree of confidence, wherein the first degree of confidence indicates a likelihood of adjusting access parameters for the first authorization token; using the first degree of confidence, determine whether to grant the authorization request; in response to determining to grant the authorization request, transmitting a response to the authorization request and processing a second set of features using a comprehensive model to determine whether to adjust the access parameters for the first authorization token to include the resources associated with the authorization request, wherein the second set of features comprises approved and declined authorization requests associated with the user account; in response to determining to adjust the access parameters for the first authorization token, adjusting the access parameters for the first authorization token to include the resources associated with the authorization request; and generating a notification to a user associated with the user account indicating the adjusted access parameters for the first authorization token.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system that adjusts access parameters for authentication tokens, in accordance with one or more embodiments.

FIG. 2 shows an illustration diagram for processing and/or modifying an authorization token using a first model and a second model, in accordance with one or more embodiments.

FIG. 3 shows illustrative components for a system for adjusting access parameters for authentication tokens, in accordance with one or more embodiments.

FIG. 4 shows a flowchart of the steps involved in adjusting access parameters for authentication tokens, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

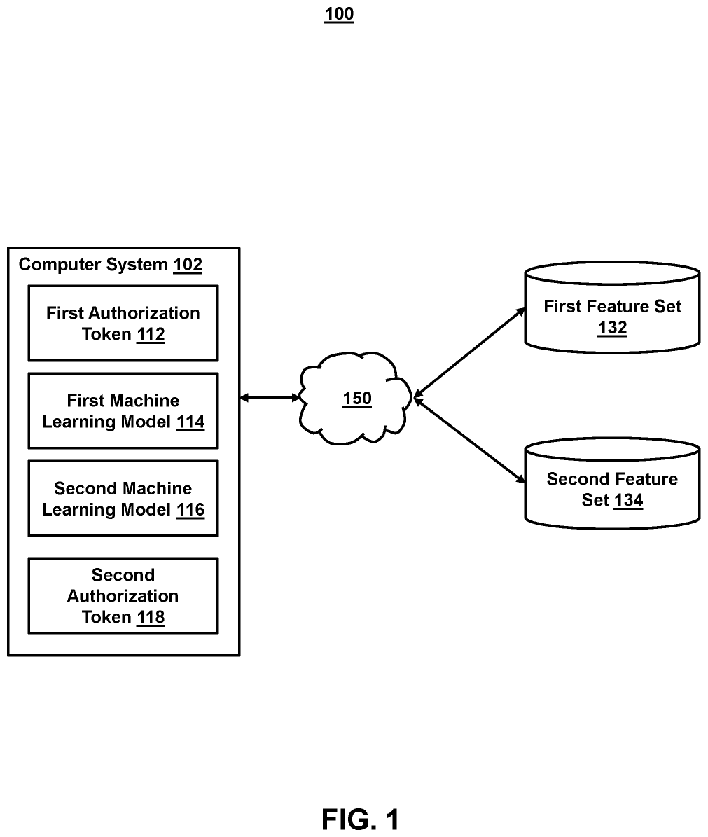

FIG. 1 shows an illustrative diagram for system 100, which contains hardware and software components connected via network 150 and used for generating synthetic data using a first Machine Learning model for a second model, in accordance with one or more embodiments. For example, Computer System 102, a part of system 100, may include First Authentication Token 112, First Machine Learning Model 114, Second Machine Learning Model 116, and Second Authentication Token 118. Additionally, system 100 may create, store, and use First Feature Set 132 and Second Feature Set 134 in one or more contexts.

The system (e.g., system 100) may receive an authorization request associated with a first authorization token (e.g., First Authentication Token 112) for a user account. For example, the system may receive a request for resource access from a user account. The authorization request may contain data indicating an identifying number of First Authentication Token 112. Additionally, the request may contain authentication information, such as a passcode. The authorization request may also include metadata like a location from which the request was transmitted, an extent of resource access, a category of resource access, and the relation between First Authentication Token 112 and the user account. The relation between the first authorization token and the user account may include parameters restricting its use of the user account, including one or more of: a category of resource access associated with the user account, a set of locations for access to the user account, a timeframe for access to the user account, or an extent of each access to the user account. The metadata included in the authorization request may additionally contain information regarding the user account. In some embodiments, the metadata includes a first set of features, including a list of recent authorization requests associated with First Authentication Token 112, a list of recent authorization requests associated with the user account, a location associated with the authorization request, and an extent of resource access associated with the authorization request. In some embodiments, the first set of features may include a location associated with the authorization request, an extent of the authorization request, and a verification associated with the first authorization token.

The system may determine that access parameters for the first authorization token (e.g., First Authentication Token 112) do not include resources associated with the authorization request. For example, First Authentication Token 112 may have an expiration parameter specifying a number of days since its first activation. The authorization request may take place after the expiration parameter would have de-activated First Authentication Token 112. In another example, an extent of the authorization request exceeds the allocation to First Authentication Token 112. In another example, a category resources of the authorization request does not match the specifications of First Authentication Token 112. In another example, the location from which the authorization request was sent was ineligible for the first authorization token. Upon determine that access parameters for First Authentication Token 112 do not include resources associated with the authorization request, the system may use a machine learning model to generate, in real time, a degree of confidence that the first authorization token should be adjusted to accommodate the authorization request.

The system may process the authorization including the first set of features (e.g., First Feature Set 132) using a real time machine learning model (e.g., First Machine Learning Model 114) to determine whether to grant the authorization request. First Machine Learning Model 114 may be, for example, a deep learning model trained to identify genuine authorization requests from fraudulent requests. First Machine Learning Model 114 may use algorithms such as logistic regression, random forests, and decision trees. First Machine Learning Model 114 may take as input values the first set of features, for example. First Machine Learning Model 114 may output a binary value indicating whether the authorization request should be approved. In some embodiments, First Machine Learning Model 114 may instead output a probability of granting the authorization request using a logistic regression algorithm. In some embodiments, First Machine Learning Model 114 may output a real number symbolizing a first degree of confidence that the parameters of First Authentication Token 112 should be adjusted, instead of or in addition to determining whether the authorization request should be approved. In some embodiments, in response to First Machine Learning Model 114 determining to deny the authorization request, the system may revoke the access to First Authentication Token 112 of the user account, or destroy the first authorization token. For example, the system may compare the first degree of confidence as output by First Machine Learning Model 114 to a threshold degree of confidence. If the first degree of confidence falls short, the system may revoke or destroy First Authentication Token 112.

First Machine Learning Model 114 may be trained on training data containing past authorization requests and/or synthetic data symbolizing potential authorization requests, each of which contains values for First Feature Set 132. In some embodiments, each authorization request may be labeled with an intended outcome. For example, the system may aggregate the outcomes of real authorization requests for the past period of time and process the authorization requests into the format of First Feature Set 132. The resultant dataset may be used as training data for First Machine Learning Model 114. Using a supervised or reinforcement learning framework, the system in this example may train First Machine Learning Model 114 on a loss metric symbolizing the alignment between the actual outcome of an authorization request and the approval or rejection indicated by First Machine Learning Model 114.

In response to the output of First Machine Learning Model 114 indicating to approve or decline the authorization request, the system may use Second Machine Learning Model 116 to determine adjustments to the parameters of First Authentication Token 112. In some embodiments, Second Machine Learning Model 116 may use a degree of confidence output by First Machine Learning Model 114 to determine whether an adjustment is necessary and may process a second set of features (e.g., Second Feature Set 134) to determine appropriate adjustments. In some embodiments, Second Machine Learning Model 116 may generate a second degree of confidence and use the second degree of confidence in combination with Second Feature Set 134 to determine which adjustments are appropriate, if any. In some embodiments, Second Machine Learning Model 116 may choose to expand the parameters of First Authentication Token 112 only in response to First Machine Learning Model 114 granting the authorization request. Similarly, Second Machine Learning Model 116 may choose to further restrict the parameters of First Authentication Token 112 only in response to First Machine Learning Model 114 denying the authorization request.

Second Machine Learning Model 116 may use as input Second Feature Set 134, which may be of a different format and capture different information than First Feature Set 132. For example, Second Feature Set 134 may include a full list of authorization requests associated with the first authorization token, comprising a category, extent, location and approval status of each resource access request, a full list of authorization requests associated with the user account, comprising a category, extent, location and approval status of each resource access request, a record of incorrect and fraudulent resource authorization requests associated with the user account. Second Machine Learning Model 116 may process Second Feature Set 134 using algorithms such as naïve bayes, neural networks, decision trees or logistic regression to generate a second degree of confidence to adjust parameters of First Authentication Token 112 and/or a target coverage for First Authentication Token 112. Second Machine Learning Model 116 may be trained on training data containing past requests for adjusting authorization tokens and/or synthetic data symbolizing potential authorization tokens, each of which contains values for Second Feature Set 134. In some embodiments, each authorization request may be labeled with an intended adjustment. The resultant dataset may be used as training data for Second Machine Learning Model 116. Using a supervised or reinforcement learning framework, the system in this example may train Second Machine Learning Model 116 on a loss metric symbolizing the alignment between real adjustments made to authorization tokens and the output of Second Machine Learning Model 116.

In some embodiments, the system may train Second Machine Learning Model 116 by training a first candidate model and a second candidate model. For example, the first candidate model may use an algorithm like a neural network. For example, the second candidate model may use a different algorithm like a decision tree. In some embodiments, the system may use part of the training data for the first candidate model and the remainder of the training data to train the second candidate model. The system may calculate, for example, fit metrics for the first and second candidate models. A fit metric may be a combination of a bias score according to a bias metric and an error score based on cross-validation for a candidate model. Alternatively, the system may calculate performance metrics for the first and second candidate models. A performance metric may indicate, for example, the adherence of a candidate model to a performance standard at runtime. In some embodiments, the system may process a candidate model to extract an attention matrix. The attention matrix may be indicative of extents of consideration the candidate model gives to each of its input features. The system may compare the attention matrix against a preset benchmark attention matrix to generate an attention score. The attention score may, for example, be used as a performance metric. Alternatively or additionally, the attention score may be used to update the candidate model. Using fit metrics and/or performance metrics corresponding to the first and second candidate models, the system may generate Second Machine Learning Model 116 by combining parameters from both candidate models as a weighted average using the metrics.

Using the output of Second Machine Learning Model 116, the system may determine a target coverage for First Authentication Token 112. For example, Second Machine Learning Model 116 may output quantitative parameters detailing a category of resource access associated with the user account, a set of locations for access to the user account, a timeframe for access to the user account; and an extent of each access to the user account. The parameters may differ for those currently ascribed to First Authentication Token 112. The system may compare the second degree of confidence output by Second Machine Learning Model 116 against a threshold degree of confidence to determine whether to actually apply the parameters suggested by Second Machine Learning Model 116. For example, if the second degree of confidence exceeds the threshold, the system may transmit a request to an account management system to update the parameters of First Authentication Token 112 in association with the user account. The system may cause the account management system to update the parameters of First Authentication Token 112 to those suggested by Second Machine Learning Model 116. This causes First Authentication Token 112 to take on the intended coverage as specified by Second Machine Learning Model 116. The system may simultaneously notify a device associated with the user account, for example detailing new parameters of First Authentication Token 112. The system may also provide an explanation for the changes to First Authentication Token 112, and may indicate whether such changes may be expected in the future.

If the second degree of confidence is below a threshold, which may be different from the one used above to determine to expand the parameters of First Authentication Token 112, the system may choose to not change the parameters of First Authentication Token 112. The system may send a notification to a device associated with the user account, the notification detailing reasons why the authorization request was approved but First Authentication Token 112 was left unchanged. If the second degree of confidence is below a third threshold, which may be lower than both the threshold used to expand the parameters and the threshold used to maintain the same parameters for First Authentication Token 112, the system may determine to revoke the access of the user account to First Authentication Token 112. The system may send a notification to a device associated with the user account, describing reasons for the revocation. For example, the system may consider First Authentication Token 112 to be at risk of abuse from malicious users, and revoke access for security reasons. In some embodiments, the system may, in lieu of adjusting the parameters of First Authentication Token 112, revoke the association between the user account and First Authentication Token 112. Instead, the system may issue Second Authentication Token 118 for use by the user account, the parameters for Second Authentication Token 118 being issued by Second Machine Learning Model 116. If the system creates Second Authentication Token 118 of its own accord without input from the user of the user account, it may notify the user with a notification specifying the parameters of Second Authentication Token 118 and the reasons for the replacement token. In some embodiments, the system may create Second Authentication Token 118 in response to a user's request. The system may use parameters output by Second Machine Learning Model 116, but may also consider parameters requested by the user.

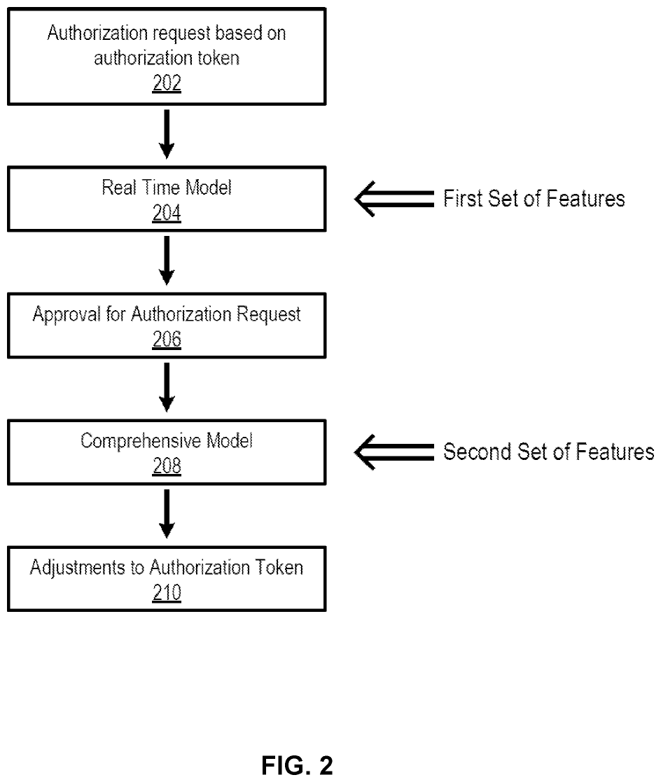

FIG. 2 shows a workflow for processing an authentication token using a first real-time machine learning model and subsequently a second comprehensive machine learning model. At operation 202, the system may receive an authorization request associated with a first authorization token (e.g., First Authentication Token 112). For example, the system may receive a request for resource access from a user account. The authorization request may contain data indicating an identifying number of First Authentication Token 112. Additionally, the request may contain authentication information, such as a passcode. The authorization request may also include metadata like a location from which the request was transmitted, an extent of resource access, a category of resource access, and the relation between First Authentication Token 112 and the user account. The relation between the first authorization token and the user account may include parameters restricting its use of the user account, including one or more of: a category of resource access associated with the user account, a set of locations for access to the user account, a timeframe for access to the user account, or an extent of each access to the user account. The metadata included in the authorization request may additionally contain information regarding the user account.

At operation 204, the system uses a real time machine learning model (e.g., First Machine Learning Model 114) to process the authorization request. In some embodiments, the system may only process the authorization request in response to determining that access parameters for the first authorization token do not include resources associated with the authorization request. In other words, in these embodiments the system may only process the authorization request and examine whether to adjust the parameters of the authorization token in response to detecting that the authorization request falls outside the bounds of the authorization token. The system may process the authorization including the first set of features (e.g., First Feature Set 132) using a real time machine learning model (e.g., First Machine Learning Model 114) to determine whether to grant the authorization request. In some embodiments, metadata associated with the authorization request includes a first set of features, including a list of recent authorization requests associated with First Authentication Token 112, a list of recent authorization requests associated with the user account, a location associated with the authorization request, and an extent of resource access associated with the authorization request. In some embodiments, the first set of features may additionally include locations associated with past authorization requests, extents of past or recent authorization requests, and a verification associated with the first authorization token.

First Machine Learning Model 114 may be, for example, a deep learning model trained to identify genuine authorization requests from fraudulent requests. First Machine Learning Model 114 may use algorithms such as logistic regression, random forests, and decision trees. First Machine Learning Model 114 may take as input values the first set of features, for example. First Machine Learning Model 114 may output a binary value indicating whether the authorization request should be approved. In some embodiments, First Machine Learning Model 114 may instead output a probability of granting the authorization request using a logistic regression algorithm. In some embodiments, First Machine Learning Model 114 may output a real number symbolizing a first degree of confidence that the parameters of First Authentication Token 112 should be adjusted, instead of or in addition to determining whether the authorization request should be approved. In some embodiments, in response to First Machine Learning Model 114 determining to deny the authorization request, the system may revoke the access to First Authentication Token 112 of the user account, or destroy the first authorization token. For example, the system may compare the first degree of confidence as output by First Machine Learning Model 114 to a threshold degree of confidence. If the first degree of confidence falls short, the system may revoke or destroy First Authentication Token 112.

At operation 206, the system forms an approval decision for the authorization request. The approval decision may be based on comparing the first degree of confidence output by First Machine Learning Model 114 against a threshold value. If the first degree of confidence is below a rejection threshold, the system may decline the authorization request and use a second machine learning model to examine whether to restrict the parameters of First Authentication Token 112. If the first degree of confidence is above an acceptance threshold, the system may use the second machine learning model to examine whether to expand the parameters of First Authentication Token 112. If the first degree of confidence is above the rejection threshold but below the acceptance threshold, the system may determine to reject or approve the authorization request based on the value of the first degree of confidence. If the first degree of confidence is closer to the rejection threshold than the acceptance threshold, the system may reject the authorization request, and vice versa.

At operation 208, the system may use a second machine learning model (e.g., Second Machine Learning Model 116) to determine adjustments to the parameters of First Authentication Token 112. In some embodiments, Second Machine Learning Model 116 may use a degree of confidence output by First Machine Learning Model 114 to determine whether an adjustment is necessary and may process a second set of features (e.g., Second Feature Set 134) to determine appropriate adjustments. In other embodiments, Second Machine Learning Model 116 may generate a second degree of confidence and use the second degree of confidence in combination with Second Feature Set 134 to determine what adjustments are appropriate, if any. In some embodiments, Second Machine Learning Model 116 may choose to expand the parameters of First Authentication Token 112 only in response to First Machine Learning Model 114 granting the authorization request. Similarly, Second Machine Learning Model 116 may choose to further restrict the parameters of First Authentication Token 112 only in response to First Machine Learning Model 114 denying the authorization request.

Second Machine Learning Model 116 may use as input Second Feature Set 134, which may be of a different format and capture different information than First Feature Set 132. For example, Second Feature Set 134 may include a full list of authorization requests associated with the first authorization token, comprising a category, extent, location and approval status of each resource access request, a full list of authorization requests associated with the user account, comprising a category, extent, location and approval status of each resource access request, a record of incorrect and fraudulent resource authorization requests associated with the user account. Second Machine Learning Model 116 may process Second Feature Set 134 using algorithms such as naïve bayes, neural networks, decision trees or logistic regression to generate a second degree of confidence to adjust parameters of First Authentication Token 112 and/or a target coverage for First Authentication Token 112. Second Machine Learning Model 116 may be trained on training data containing past requests for adjusting authorization tokens and/or synthetic data symbolizing potential authorization tokens, each of which contains values for Second Feature Set 134. In some embodiments, each authorization request may be labeled with an intended adjustment. The resultant dataset may be used as training data for Second Machine Learning Model 116. Using a supervised or reinforcement learning framework, the system in this example may train Second Machine Learning Model 116 on a loss metric symbolizing the alignment between real adjustments made to authorization tokens and the output of Second Machine Learning Model 116.

At operation 210, the system may adjust the access parameters for the first authorization token based on the output of Second Machine Learning Model 116, such as a second degree of confidence. Using the output of Second Machine Learning Model 116, the system may determine a target coverage for First Authentication Token 112. For example, Second Machine Learning Model 116 may output quantitative parameters detailing a category of resource access associated with the user account, a set of locations for access to the user account, a timeframe for access to the user account; and an extent of each access to the user account. The parameters may differ for those currently ascribed to First Authentication Token 112. The system may compare the second degree of confidence output by Second Machine Learning Model 116 against a threshold degree of confidence to determine whether to actually apply the parameters suggested by Second Machine Learning Model 116. For example, if the second degree of confidence exceeds the threshold, the system may transmit a request to an account management system to update the parameters of First Authentication Token 112 in association with the user account. The system may cause the account management system to update the parameters of First Authentication Token 112 to those suggested by Second Machine Learning Model 116. This causes First Authentication Token 112 to take on the intended coverage as specified by Second Machine Learning Model 116. The system may, simultaneously to adjusting the parameters of First Authentication Token 112, notify a device associated with the user account, for example detailing new parameters of First Authentication Token 112. The system may also provide an explanation for the changes to First Authentication Token 112, and may indicate whether such changes may be expected in the future.

If the second degree of confidence is below a threshold, which may be different from the one used above to determine to expand the parameters of First Authentication Token 112, the system may choose to not change the parameters of First Authentication Token 112. The system may send a notification to a device associated with the user account, the notification detailing reasons why the authorization request was approved but First Authentication Token 112 was left unchanged. If the second degree of confidence is below a third threshold, which may be lower than both the threshold used to expand the parameters and the threshold used to maintain the same parameters for First Authentication Token 112, the system may determine to revoke the access of the user account to First Authentication Token 112. The system may send a notification to a device associated with the user account, describing reasons for the revocation.

In one example embodiment, the system receives a request to use an authentication token such as a virtual card number for a purchase on a store's website. The virtual card number may be associated with a user account, but may be bound by parameters limiting its usage. For example, the virtual card number may be bound to one online merchant in an effort to protect the cybersecurity and confidentiality of the user account. However, the request in this embodiment may fall outside the parameters limiting the virtual card number, for example being directed to a different online merchant than specified by the parameters. In response to receiving the request, the system may process the request using a first machine learning model to generate a first degree of confidence. The first degree of confidence may symbolize whether the request should be approved in this instance for the merchant outside the parameters of the virtual card number. In some embodiments, the first degree of confidence may not relate to whether the parameters of the virtual card number should be adjusted; rather, the first degree of confidence may relate only to whether the request to use the virtual card number as a representation of the user account at the merchant is legitimate in this instance. In other words, the first degree of confidence may only be used to approve the transaction in this instance, without regard to the usage of the virtual card number in future transactions. The system may then process the account state, the authorization request, and/or a comprehensive history of the usage of the authentication token in connection with the user account using a second machine learning model to generate a second degree of confidence. The second degree of confidence indicates a likelihood of adjusting access parameters for the virtual card number. For example, based on the second degree of confidence, the system may unbind the virtual card number from the merchant it was locked to. Instead, the system may bind the virtual card number to a category of transaction, additionally or alternatively to a geofence limiting areas where the virtual card number can access the user account. In some embodiments, the system may determine to revoke the virtual card number for the user account due to the second degree of confidence being lower than a rejection threshold. When adjusting parameters of the virtual card number or when adjusting its access to the user account, the system may send a notification to the user describing reasons for the changes.

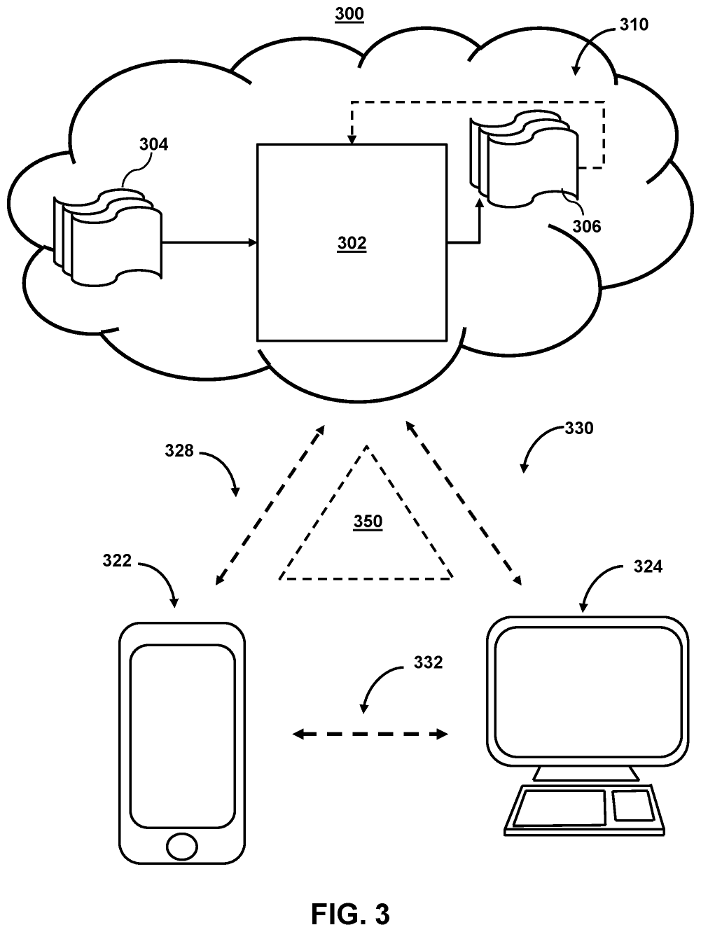

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

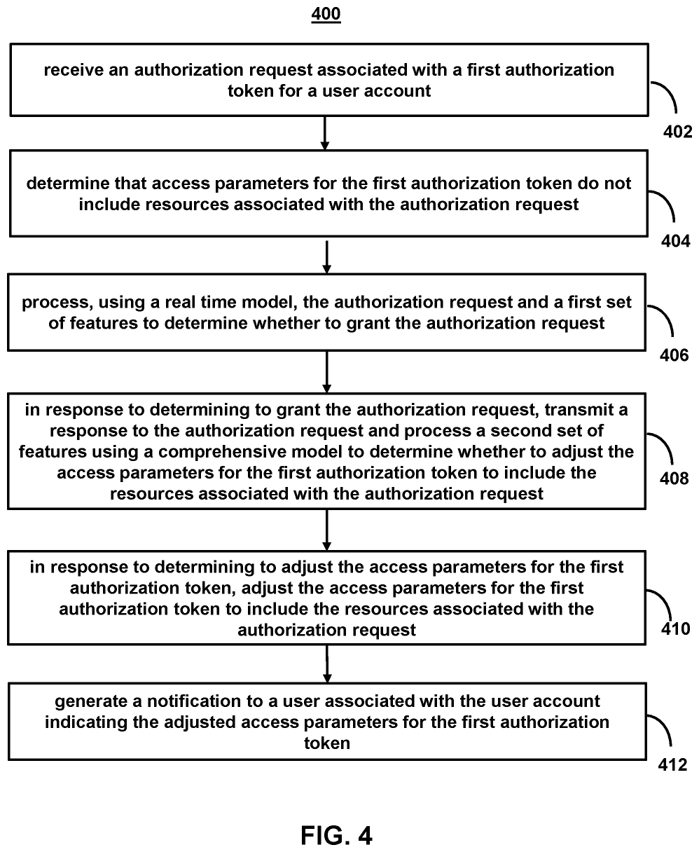

FIG. 4 shows a flowchart of the steps involved in generating synthetic data using a first Machine Learning model for a second model, in accordance with one or more embodiments. For example, the system may use process 400 (e.g., as implemented on one or more system components described above) in order to process plain-text behavior descriptions using a first model to generate representations in a real-valued space, use the representations to create behavior token sequences, and use the behavior token sequences to train or update a second model.

At step 402, process 400 (e.g., using one or more components described above) receives an authorization request associated with a first authorization token for a user account. The system (e.g., system 100) may receive an authorization request associated with a first authorization token (e.g., First Authentication Token 112) for a user account. For example, the system may receive a request for resource access from a user account. The authorization request may contain data indicating an identifying number of First Authentication Token 112. Additionally, the request may contain authentication information, such as a passcode. The authorization request may also include metadata like a location from which the request was transmitted, an extent of resource access, a category of resource access, and the relation between First Authentication Token 112 and the user account. The relation between the first authorization token and the user account may include parameters restricting its use of the user account, including one or more of: a category of resource access associated with the user account, a set of locations for access to the user account, a timeframe for access to the user account, or an extent of each access to the user account. The metadata included in the authorization request may additionally contain information regarding the user account. In some embodiments, the metadata includes a first set of features, including a list of recent authorization requests associated with First Authentication Token 112, a list of recent authorization requests associated with the user account, a location associated with the authorization request, and an extent of resource access associated with the authorization request. In some embodiments, the first set of features may additionally include locations associated with past authorization requests, extents of past or recent authorization request, and a verification associated with the first authorization token.

At step 404, process 400 (e.g., using one or more components described above) determine that access parameters for the first authorization token do not include resources associated with the authorization request. The system may determine that access parameters for the first authorization token (e.g., First Authentication Token 112) do not include resources associated with the authorization request. For example, First Authentication Token 112 may have an expiration parameter specifying a number of days since its first activation. The authorization request may take place after the expiration parameter would have de-activated First Authentication Token 112. In another example, an extent of the authorization request exceeds the allocation to First Authentication Token 112. In another example, a category resources of the authorization request does not match the specifications of First Authentication Token 112. In another example, the location from which the authorization request was sent was ineligible for the first authorization token. Upon determining that access parameters for First Authentication Token 112 do not include resources associated with the authorization request, the system may use a machine learning model to generate, in real time, a degree of confidence that the first authorization token should be adjusted to accommodate the authorization request.

At step 406, process 400 (e.g., using one or more components described above) processes, using a real time model, the authorization request and a first set of features to determine whether to grant the authorization request. The system may process the authorization including the first set of features (e.g., First Feature Set 132) using a real time machine learning model (e.g., First Machine Learning Model 114) to determine whether to grant the authorization request. First Machine Learning Model 114 may be, for example, a deep learning model trained to identify genuine authorization requests from fraudulent requests. First Machine Learning Model 114 may use algorithms such as logistic regression, random forests, and decision trees. First Machine Learning Model 114 may take as input values the first set of features, for example. First Machine Learning Model 114 may output a binary value indicating whether the authorization request should be approved. In some embodiments, First Machine Learning Model 114 may instead output a probability of granting the authorization request using a logistic regression algorithm. In some embodiments, First Machine Learning Model 114 may output a real number symbolizing a first degree of confidence that the parameters of First Authentication Token 112 should be adjusted, instead of or in addition to determining whether the authorization request should be approved. In some embodiments, in response to First Machine Learning Model 114 determining to deny the authorization request, the system may revoke the access to First Authentication Token 112 of the user account, or destroy the first authorization token. For example, the system may compare the first degree of confidence as output by First Machine Learning Model 114 to a threshold degree of confidence. If the first degree of confidence falls short, the system may revoke or destroy First Authentication Token 112.

First Machine Learning Model 114 may be trained on training data containing past authorization requests and/or synthetic data symbolizing potential authorization requests, each of which contains values for First Feature Set 132. In some embodiments, each authorization request may be labeled with an intended outcome. For example, the system may aggregate the outcomes of real authorization requests for the past period of time and process the authorization requests into the format of First Feature Set 132. The resultant dataset may be used as training data for First Machine Learning Model 114. Using a supervised or reinforcement learning framework, the system in this example may train First Machine Learning Model 114 on a loss metric symbolizing the alignment between the actual outcome of an authorization request and the approval or rejection indicated by First Machine Learning Model 114.

At step 408, process 400 (e.g., using one or more components described above), in response to determining to grant the authorization request, transmits a response to the authorization request and process a second set of features using a comprehensive model to determine whether to adjust the access parameters for the first authorization token to include the resources associated with the authorization request. In response to the output of First Machine Learning Model 114 indicating to approve or decline the authorization request, the system may use Second Machine Learning Model 116 to determine adjustments to the parameters of First Authentication Token 112. In some embodiments, Second Machine Learning Model 116 may use a degree of confidence output by First Machine Learning Model 114 to determine whether an adjustment is necessary, and may process a second set of features (e.g., Second Feature Set 134) to determine appropriate adjustments. In other embodiments, Second Machine Learning Model 116 may generate a second degree of confidence, and use the second degree of confidence in combination with Second Feature Set 134 to determine what adjustments are appropriate, if any. In some embodiments, Second Machine Learning Model 116 may choose to expand the parameters of First Authentication Token 112 only in response to First Machine Learning Model 114 granting the authorization request. Similarly, Second Machine Learning Model 116 may choose to further restrict the parameters of First Authentication Token 112 only in response to First Machine Learning Model 114 denying the authorization request.

Second Machine Learning Model 116 may use as input Second Feature Set 134, which may be of a different format and capture different information than First Feature Set 132. For example, Second Feature Set 134 may include a full list of authorization requests associated with the first authorization token, comprising a category, extent, location and approval status of each resource access request, a full list of authorization requests associated with the user account, comprising a category, extent, location and approval status of each resource access request, a record of incorrect and fraudulent resource authorization requests associated with the user account. Second Machine Learning Model 116 may process Second Feature Set 134 using algorithms such as naïve bayes, neural networks, decision trees or logistic regression to generate a second degree of confidence to adjust parameters of First Authentication Token 112 and/or a target coverage for First Authentication Token 112. Second Machine Learning Model 116 may be trained on training data containing past requests for adjusting authorization tokens and/or synthetic data symbolizing potential authorization tokens, each of which contains values for Second Feature Set 134. In some embodiments, each authorization request may be labeled with an intended adjustment. The resultant dataset may be used as training data for Second Machine Learning Model 116. Using a supervised or reinforcement learning framework, the system in this example may train Second Machine Learning Model 116 on a loss metric symbolizing the alignment between real adjustments made to authorization tokens and the output of Second Machine Learning Model 116.

In some embodiments, the system may train Second Machine Learning Model 116 by training a first candidate model and a second candidate model. For example, the first candidate model may use an algorithm like a neural network. For example, the second candidate model may use a different algorithm like a decision tree. In some embodiments, the system may use part of the training data for the first candidate model and the remainder of the training data to train the second candidate model. The system may calculate, for example, fit metrics for the first and second candidate models. A fit metric may be a combination of a bias score according to a bias metric and an error score based on cross-validation for a candidate model. Alternatively, the system may calculate performance metrics for the first and second candidate models. A performance metric may indicate, for example, the adherence of a candidate model to a performance standard at runtime. In some embodiments, the system may process a candidate model to extract an attention matrix. The attention matrix may be indicative of extents of consideration the candidate model gives to each of its input features. The system may compare the attention matrix against a preset benchmark attention matrix to generate an attention score. The attention score may, for example, be used as a performance metric. Alternatively or additionally, the attention score may be used to update the candidate model. Using fit metrics and/or performance metrics corresponding to the first and second candidate models, the system may generate Second Machine Learning Model 116 by combining parameters from both candidate models as a weighted average using the metrics. At step 410, process 400 (e.g., using one or more components described above), in response to determining to adjust the access parameters for the first authorization token, adjusts the access parameters for the first authorization token to include the resources associated with the authorization request. Using the output of Second Machine Learning Model 116, the system may determine a target coverage for First Authentication Token 112. For example, Second Machine Learning Model 116 may output quantitative parameters detailing a category of resource access associated with the user account, a set of locations for access to the user account, a timeframe for access to the user account; and an extent of each access to the user account. The parameters may differ for those currently ascribed to First Authentication Token 112. The system may compare the second degree of confidence output by Second Machine Learning Model 116 against a threshold degree of confidence to determine whether to actually apply the parameters suggested by Second Machine Learning Model 116. For example, if the second degree of confidence exceeds the threshold, the system may transmit a request to an account management system to update the parameters of First Authentication Token 112 in association with the user account. The system may cause the account management system to update the parameters of First Authentication Token 112 to those suggested by Second Machine Learning Model 116. This causes First Authentication Token 112 to take on the intended coverage as specified by Second Machine Learning Model 116.

At step 412, process 400 (e.g., using one or more components described above) generates a notification to a user associated with the user account indicating the adjusted access parameters for the first authorization token. The system may, simultaneously to adjusting the parameters of First Authentication Token 112, notify a device associated with the user account, for example detailing new parameters of First Authentication Token 112. The system may also provide an explanation for the changes to First Authentication Token 112, and may indicate whether such changes may be expected in the future.

If the second degree of confidence is below a threshold, which may be different from the one used above to determine to expand the parameters of First Authentication Token 112, the system may choose to not change the parameters of First Authentication Token 112. The system may send a notification to a device associated with the user account, the notification detailing reasons why the authorization request was approved but First Authentication Token 112 was left unchanged. If the second degree of confidence is below a third threshold, which may be lower than both the threshold used to expand the parameters and the threshold used to maintain the same parameters for First Authentication Token 112, the system may determine to revoke the access of the user account to First Authentication Token 112. The system may send a notification to a device associated with the user account, describing reasons for the revocation. For example, the system may consider First Authentication Token 112 to be at risk of abuse from malicious users, and revoke access for security reasons. In some embodiments, the system may, in lieu of adjusting the parameters of First Authentication Token 112, revoke the association between the user account and First Authentication Token 112. Instead, the system may issue Second Authentication Token 118 for use by the user account, the parameters for Second Authentication Token 118 being issued by Second Machine Learning Model 116. If the system creates Second Authentication Token 118 of its own accord without input from the user of the user account, it may notify the user with a notification specifying the parameters of Second Authentication Token 118 and the reasons for the replacement token. In some embodiments, the system may create Second Authentication Token 118 in response to a user's request. The system may use parameters output by Second Machine Learning Model 116, but may also consider parameters requested by the user.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving an authorization request associated with a first authorization token for a user account; determining that access parameters for the first authorization token do not include resources associated with the authorization request; processing, using a real time model, the authorization request and a first set of features to determine whether to grant the authorization request, wherein the first set of features comprises a location associated with the authorization request, an extent of the authorization re quest, and a verification associated with the first authorization token; in response to determining to grant the authorization request, transmitting a response to the authorization request and processing a second set of features using a comprehensive model to determine whether to adjust the access parameters for the first authorization token to include the resources associated with the authorization request, wherein the second set of features comprises approved and declined authorization requests associated with the user account; in response to determining to adjust the access parameters for the first authorization token, adjusting the access parameters for the first authorization token to include the resources associated with the authorization request; and generating a notification to a user associated with the user account indicating the adjusted access parameters for the first authorization token.
2. A method comprising: receiving an authorization request associated with a first authorization token for a user account; determining that access parameters for the first authorization token do not include resources associated with the authorization request; processing, using a real time model, the authorization request and a first set of features to determine whether to grant the authorization request; in response to determining to grant the authorization request, transmitting a response to the authorization request and processing a second set of features using a comprehensive model to determine whether to adjust the access parameters for the first authorization token to include the resources associated with the authorization request; in response to determining to adjust the access parameters for the first authorization token, adjusting the access parameters for the first authorization token to include the resources associated with the authorization request; and generating a notification to a user associated with the user account indicating the adjusted access parameters for the first authorization token.
3. The method of any one of the preceding embodiments, wherein the first set of features comprises: a list of recent authorization requests associated with the first authorization token; a list of recent authorization requests associated with the user account; a location associated with the authorization request; and an extent of resource access associated with the authorization request.
4. The method of any one of the preceding embodiments, wherein the real time model processes the first set of features to generate a probability of granting the authorization request using a logistic regression algorithm.
5. The method of any one of the preceding embodiments, wherein the second set of features comprises: a full list of authorization requests associated with the first authorization token, comprising a category, extent, location and approval status of each resource access request; a full list of authorization requests associated with the user account, comprising a category, extent, location and approval status of each resource access request; and a record of incorrect and fraudulent resource authorization requests associated with the user account.
6. The method of any one of the preceding embodiments, wherein the first authorization token comprises parameters restricting its use of the user account, comprising: a category of resource access associated with the user account; a set of locations for access to the user account; a timeframe for access to the user account; and an extent of each access to the user account.
7. The method of any one of the preceding embodiments, wherein the comprehensive model processes the second set of features to generate a target coverage for the first authorization token.
8. The method of any one of the preceding embodiments, further comprising: determine a first discrepancy using the target coverage and the parameters defining the first authorization token; and using the first discrepancy, updating the parameters defining the first authorization token.
9. The method of any one of the preceding embodiments, further comprising: using an output of the comprehensive model, determining to issue a second authorization token; selecting a set of parameters for the second authorization token using the output of the comprehensive model; generating the second authorization token using the set of parameters; and sending a notification to the user indicating that the second authorization token is associated with the set of parameters.
10. The method of any one of the preceding embodiments, further comprising: receiving feedback comprising a first set of outcomes associated with the adjusted authorization token; and using the first set of outcomes as training data, updating the comprehensive model.
11. The method of any one of the preceding embodiments, further comprising: determining not to adjust parameters defining the first authorization token; and revoking access of the first authorization token to the user account.
12. A method comprising: receiving an authorization request associated with a first authorization token for a user account; determining that access parameters for the first authorization token do not include resources associated with the authorization request; processing, using a real time model, the authorization request and a first set of features to generate a first degree of confidence, wherein the first degree of confidence indicates a likelihood of adjusting access parameters for the first authorization token; using the first degree of confidence, determine whether to grant the authorization request; in response to determining to decline the authorization request, transmitting a response to the authorization request and processing a second set of features using a comprehensive model to determine whether to adjust the access parameters for the first authorization token to include the resources associated with the authorization request, wherein the second set of features comprises approved and declined authorization requests associated with the user account; in response to determining to adjust the access parameters for the first authorization token, adjusting the access parameters for the first authorization token to include the resources associated with the authorization request; and generating a notification to a user associated with the user account indicating the declined authorization request and the adjusted access parameters for the first authorization token.
13. One or more non-transitory computer-readable media storing instructions that, when executed by a data processing apparatus, cause the data processing apparatus to perform operations comprising those of any of embodiments 1-12.
14. A system comprising one or more processors; and one or more non-transitory computer-readable media storing instructions that, when executed by the one or more processors, cause the one or more processors to effectuate operations comprising those of any of embodiments 1-12.
15. A system comprising means for performing any of embodiments 1-12.

What is claimed is:

1. A system for adjusting access parameters for an authorization token, the system comprising:
receiving an authorization request associated with a first authorization token for a user account;
determining that access parameters for the first authorization token do not include resources associated with the authorization request;
processing, using a real time model, the authorization request and a first set of features to generate a first degree of confidence, wherein the first degree of confidence indicates a likelihood of adjusting access parameters for the first authorization token;
using the first degree of confidence, determine whether to grant the authorization request;
in response to determining to grant the authorization request, transmitting a response to the authorization request and processing a second set of features using a comprehensive model to generate a second degree of confidence, wherein the second degree of confidence indicates a likelihood of adjusting access parameters for the first authorization token, and wherein the second set of features comprises approved and declined authorization requests associated with the user account;
using the second degree of confidence, determining whether to adjust the access parameters for the first authorization token to include the resources associated with the authorization request;
in response to determining to adjust the access parameters for the first authorization token, adjusting the access parameters for the first authorization token to include the resources associated with the authorization request; and
generating a notification to a user associated with the user account indicating the adjusted access parameters for the first authorization token.

2. A method for adjusting parameters of authorization tokens, the method comprising:
receiving an authorization request associated with a first authorization token for a user account;
determining that access parameters for the first authorization token do not include resources associated with the authorization request;
processing, using a real time model, the authorization request and a first set of features to generate a first degree of confidence, wherein the first degree of confidence indicates a likelihood of adjusting access parameters for the first authorization token;
using the first degree of confidence, determine whether to grant the authorization request;
in response to determining to grant the authorization request, transmitting a response to the authorization request and processing a second set of features using a comprehensive model to determine whether to adjust the access parameters for the first authorization token to include the resources associated with the authorization request, wherein the second set of features comprises approved and declined authorization requests associated with the user account;
in response to determining to adjust the access parameters for the first authorization token, adjusting the access parameters for the first authorization token to include the resources associated with the authorization request; and
generating a notification to a user associated with the user account indicating the adjusted access parameters for the first authorization token.

3. The method of claim 2, wherein the first set of features comprises:
a list of recent authorization requests associated with the first authorization token;
a list of recent authorization requests associated with the user account, wherein the user account is associated with the first authorization token and at least one other authorization token;
a location associated with the authorization request; or
an extent of resource access associated with the authorization request.

4. The method of claim 2, wherein the real time model processes the first set of features to generate a probability of granting the authorization request using a logistic regression algorithm.

5. The method of claim 2, wherein the second set of features comprises:
a full list of authorization requests associated with the first authorization token, comprising a category, extent, location and approval status of each resource access request;
a full list of authorization requests associated with the user account, comprising a category, extent, location and approval status of each resource access request; and
a record of incorrect and fraudulent resource authorization requests associated with the user account.

6. The method of claim 2, wherein the first authorization token comprises parameters restricting its use of the user account, comprising:
a category of resource access associated with the user account;
a set of locations for access to the user account;
a timeframe for access to the user account; and
an extent of each access to the user account.

7. The method of claim 2, wherein the comprehensive model processes the second set of features to generate a target coverage for the first authorization token.

8. The method of claim 7, further comprising:
determine a first discrepancy using the target coverage and the parameters defining the first authorization token; and
using the first discrepancy, updating the parameters defining the first authorization token.

9. The method of claim 2, further comprising:
using an output of the comprehensive model, determining to issue a second authorization token;
selecting a set of parameters for the second authorization token using the output of the comprehensive model;
generating the second authorization token using the set of parameters; and
sending a notification to the user indicating that the second authorization token is associated with the set of parameters.

10. The method of claim 2, further comprising:
receiving feedback comprising a first set of outcomes associated with the adjusted authorization token; and
using the first set of outcomes as training data, updating the comprehensive model.

11. The method of claim 2, further comprising:
determining not to adjust parameters defining the first authorization token; and
revoking access of the first authorization token to the user account.

12. One or more non-transitory computer-readable media comprising instructions that, when executed by one or more processors, cause operations comprising:
receiving an authorization request associated with a first authorization token for a user account;
determining that access parameters for the first authorization token do not include resources associated with the authorization request;
processing, using a real time model, the authorization request and a first set of features to generate a first degree of confidence, wherein the first degree of confidence indicates a likelihood of adjusting access parameters for the first authorization token;
using the first degree of confidence, determine whether to grant the authorization request;
in response to determining to decline the authorization request, transmitting a response to the authorization request and processing a second set of features using a comprehensive model to determine whether to adjust the access parameters for the first authorization token to include the resources associated with the authorization request, wherein the second set of features comprises approved and declined authorization requests associated with the user account;
in response to determining to adjust the access parameters for the first authorization token, adjusting the access parameters for the first authorization token to include the resources associated with the authorization request; and
generating a notification to a user associated with the user account indicating the declined authorization request and the adjusted access parameters for the first authorization token.

13. The one or more non-transitory computer-readable media of claim 12, wherein the first set of features comprises:
a list of recent authorization requests associated with the first authorization token;
a list of recent authorization requests associated with the user account;
a location associated with the authorization request; and
an extent of resource access associated with the authorization request.

14. The one or more non-transitory computer-readable media of claim 12, wherein the real time model processes the first set of features to generate a probability of accepting the authorization request using a logistic regression algorithm.

15. The one or more non-transitory computer-readable media of claim 12, wherein the second set of features comprises:
a full list of authorization requests associated with the first authorization token, comprising a category, extent, location and approval status of each resource access request;
a full list of authorization requests associated with the user account, comprising a category, extent, location and approval status of each resource access request; and
a record of incorrect and fraudulent resource authorization requests associated with the user account.

16. The one or more non-transitory computer-readable media of claim 12, wherein the first authorization token comprises parameters restricting its use of the user account, comprising:
a category of resource access associated with the user account;
a set of locations for access to the user account;
a timeframe for access to the user account; and
an extent of each access to the user account.

17. The one or more non-transitory computer-readable media of claim 12, wherein the comprehensive model processes the second set of features to generate a target coverage for the first authorization token.

18. The one or more non-transitory computer-readable media of claim 17, further comprising:
determine a first discrepancy using the target coverage and the access parameters defining the first authorization token;
using the first discrepancy, updating the access parameters defining the first authorization token.

19. The one or more non-transitory computer-readable media of claim 12, further comprising:
using an output of the comprehensive model, determining to issue a second authorization token;
selecting a set of parameters for the second authorization token using the output of the comprehensive model;
generating the second authorization token using the set of parameters;
sending a notification to the user indicating that the second authorization token is associated with the set of parameters.

20. The one or more non-transitory computer-readable media of claim 12, further comprising:
receiving feedback comprising a first set of outcomes associated with the adjusted authorization token; and
using the first set of outcomes as training data, updating the comprehensive model.
